(19) United States
(12) Patent Application Publication
(10) Pub. No.: US 2012/0281760 A1
(43) Pub. Date: Nov. 8, 2012

(54) Iterative Grid-Pattern Motion Search

(76) Inventor: Hyung Joon Kim, McKinney, TX (US)

(21) Appl. No.: 13/438,669

(22) Filed: Apr. 3, 2012

Related U.S. Application Data
(60) Provisional application No. 61/482,338, filed on May 4, 2011.

(51) Int. Cl. H04N 7/34

(52) U.S. Cl. 375/240.16; 375/E07.108

(57) ABSTRACT

Iterative grid-pattern motion search may be performed for each macroblock of a frame of video data. A first motion search is performed from an initial best search point on a set of search points in the prior frame corresponding to a sub-set of pels within the macroblock to determine a best search point. Additional motion searches are performed iteratively, wherein each motion search is on a set of search points in the prior frame centered around a best search point determined in a preceding motion search. The motion vector for the macroblock is then estimated using a best search point determined in a final motion search iteration. A current best search point may be modified prior to performing an additional motion search by shifting to an adjacent search point in a direction indicated by the current best search point.

### CROSS-REFERENCE TO RELATED APPLICATIONS

This application claims benefit of U.S. Provisional Patent Application Ser. No. 61/482,338, filed May 4, 2011, entitled “Iterative Grid-Pattern Motion Search Method” which is incorporated by reference herein in its entirety.

### BACKGROUND

1. Field of the Invention

Embodiments of the present invention generally relate to reducing the amount of computation required for determining motion vectors for use in video compression, particularly during times of fast panning and complex motion.

2. Description of the Related Art

Information about motion within video sequences may be used by video compression systems such as MPEG to reduce the size of the resulting bit stream, or file. To accomplish this, however, the encoder must first analyze signal content to determine motion between frames, referred to as “motion estimation”, then apply this information in a manner that minimizes loss of information entropy) of the coded video signal. This is referred to as “motion compensation”.

Motion estimation (ME) may be the most computationally demanding subsystem of an MPEG encoder. Efficient and robust ME is critical for real-time encoding of MPEG video.

Although the MPEG specification does not explicitly describe the encoding process, it does dictate how the encoder must generate the video bit stream so that it can be decoded by a “model decoder.” Consequently, various encoding algorithms may be used as long as the integrity of the output bit stream is maintained. In a simplified MPEG encoder, motion estimation refers to the encoding step where a video frame is partitioned into non-overlapping 16×16 macroblocks (MBs). For each MB, the encoder attempts to estimate the motion with respect to some reference frame. The output of the ME is a motion vector for each MB and is then fed into the motion compensation system, where the differences between the MB and the predicted 16x16 blocks in the reference frame are entropy coded. Essentially, the ME attempts to exploit the temporal redundancy present in a video sequence.

ME plays a different role in each type of the three frame types defined by the MPEG coding standard: I (Intra) frames utilize no motion estimation, and are intracoded; P (Predicted) frames utilize forward prediction; and B (Bidirectional Predicted) frames utilize both forward and backward prediction.

The H.264 standard is described in detail in ITU-T Rec. H.264|ISO/IEC 14496-10, “Advanced video coding for generic audiovisual services,” 2005, or later versions, for example.

### SUMMARY

Iterative grid-pattern motion search may be performed for each macroblock of a frame of video data. A first motion search is performed from an initial best search point on a set of search points in the prior frame corresponding to a sub-set of pels within the macroblock to determine a best search point. Additional motion searches are performed iteratively, wherein each motion search is on a set of search points in the prior frame centered around a best search point determined in a preceding motion search. The motion vector for the macroblock is then estimated using a best search point determined in a final motion search iteration. A current best search point may be modified prior to performing an additional motion search by shifting to an adjacent search point in a direction indicated by the current best search point.

### BRIEF DESCRIPTION OF THE DRAWINGS

Particular embodiments will now be described, by way of example only, and with reference to the accompanying drawings:

FIG. 1 shows a block diagram of a digital system;

FIGS. 2 and 3 illustrate block diagrams of a video encoder;

FIGS. 4-7 illustrate iterative grid-pattern motion search by the encoder of FIG. 3;

FIG. 8 is a flow diagram of iterative grid-pattern motion search;

FIG. 9 illustrates an example of multiple ranges with R =5;

FIG. 10 illustrates a dual grid search; and

FIG. 11 is a block diagram of an illustrative digital system.

### DETAILED DESCRIPTION OF EMBODIMENTS

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, while various embodiments of the invention are described herein in accordance with the H.264 video coding standard, embodiments for other video coding standards will be understood by one of ordinary skill in the art. Accordingly, embodiments of the invention should not be considered limited to the H.264 video coding standard.

In hybrid video codec systems, motion estimation plays a very important role to achieve high compression efficiency by removing temporal redundancy. Grid-pattern motion estimation has been used for a wide range of hardware implementations because of its simplicity and effectiveness. Typically, the grid-pattern estimation method may be configured to provide good performance with a moderate computation load for videos with regular or low motion. However, the method fails to find accurate prediction for videos with fast panning and complex motion. Also, prior grid-pattern estimation schemes do not provide computation scalability on applications with various computational power.

Embodiments of the invention perform an iterative grid-pattern search for integer-pel motion refinement to produce accurate prediction. Computation complexity of the method can be easily controlled by adjusting the number of grid-pattern search iterations. Iterative grid-pattern search substantially improves encoding efficiency for videos with fast panning and complex motion. The iteration process may include an early termination algorithm to reduce redundant computation for low or uniform motion videos.

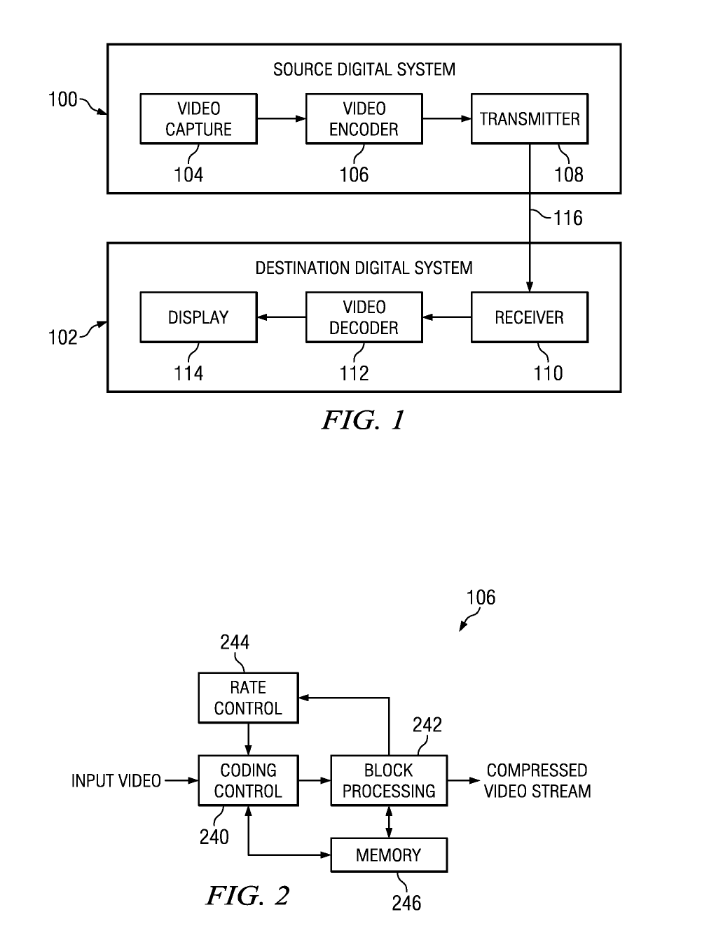

FIG. 1 shows a block diagram of a digital system in accordance with one or more embodiments. The system includes a source digital system 100 that transmits encoded video sequences to a destination digital system 102 via a communication channel 116. The source digital system 100 includes a video capture component 104, a video encoder component 106 and a transmitter component 108. The video capture component 104 is configured to provide a video sequence to be encoded by the video encoder component 106. The video capture component 104 may be for example, a video camera, a video archive, or a video feed from a video content provider. In some embodiments, the video capture component 104 may generate computer graphics as the video sequence, or a combination of live video, archived video, and/or computer-generated video.

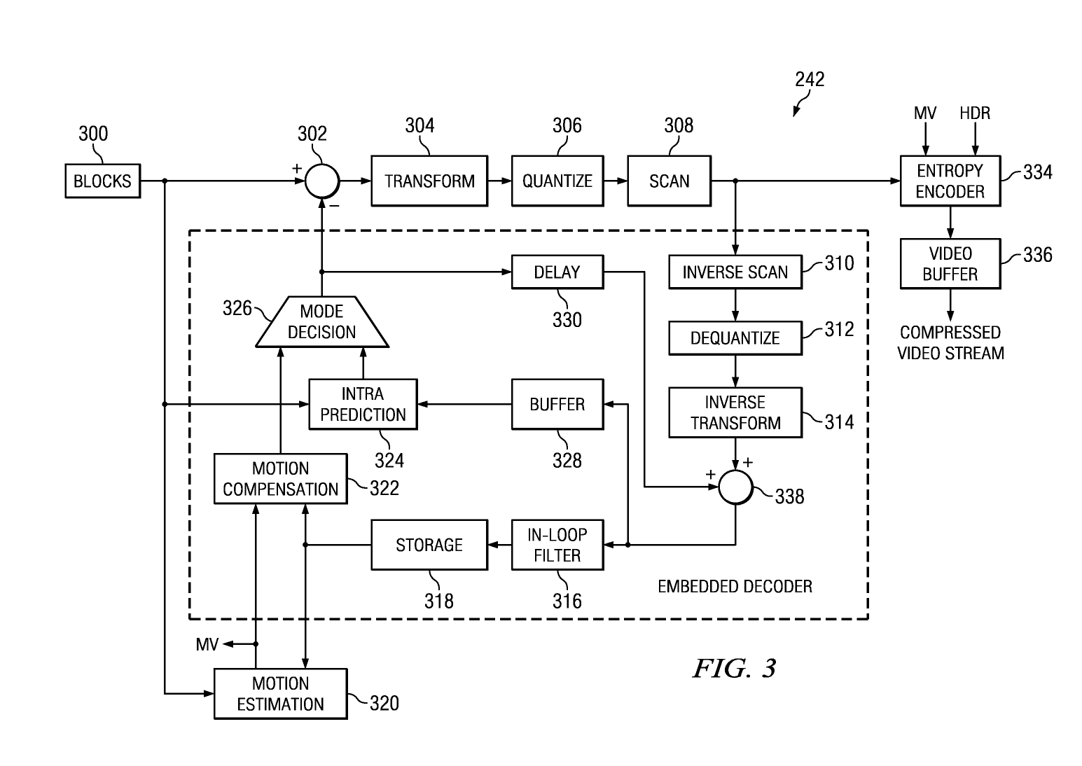

The video encoder component 106 receives a video sequence from the video capture component 104 and encodes it for transmission by the transmitter component 108. The video encoder component 106 receives the video sequence from the video capture component 104 as a sequence of pictures, divides the pictures into macroblocks and encodes the video data in the macroblocks. The video encoder component 106 may be configured to use the iterative grid-pattern motion search process as will be described in more detail below. Embodiments of the video encoder component 106 are described in more detail below in reference to FIGS. 2 and 3.

The transmitter component 108 transmits the encoded video data to the destination digital system 102 via the communication channel 116. The communication channel 116 may be any communication medium, or combination of communication media suitable for transmission of the encoded video sequence, such as, for example, wired or wireless communication media, a local area network, or a wide area network.

The destination digital system 102 includes a receiver component 110, a video decoder component 112 and a display component 114. The receiver component 110 receives the encoded video data from the source digital system 100 via the communication channel 116 and provides the encoded video data to the video decoder component 112 for decoding. The video decoder component 112 reverses the encoding process performed by the video encoder component 106 to reconstruct the macroblocks of the video sequence. The reconstructed video sequence is displayed on the display component 114. The display component 114 may be any suitable display device such as, for example, a plasma display, a liquid crystal display (LCD), a light emitting diode (LED) display, etc.

In some embodiments, the source digital system 100 may also include a receiver component and a video decoder component and/or the destination digital system 102 may include a transmitter component and a video encoder component for transmission of video sequences both directions for video streaming, video broadcasting, video conferencing, gaming, and video telephony. Further, the video encoder component 106 and the video decoder component 112 may perform encoding and decoding in accordance with one or more video compression standards. The video encoder component 106 and the video decoder component 112 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIGS. 2 and 3 illustrate block diagrams of a video encoder, e.g., the video encoder 106 of FIG. 1, configured to perform iterative grid-pattern motion search to provide good performance on high speed motion while maintaining a reasonable computation load for real-time encoding. FIG. 2 illustrates a high level block diagram of the video encoder and FIG. 3 illustrates a block diagram of the block processing component 242 of the video encoder.

As shown in FIG. 2, video encoder 106 includes a coding control component 240, a block processing component 242, a rate control component 244, and a memory 246. The memory 246 may be internal memory, external memory, or a combination thereof. The memory 246 may be used, for example, to store information for communication between the various components of the video encoder.

An input digital video sequence is provided to the coding control component 240. The coding control component 240 sequences the various operations of the video encoder, i.e., the coding control component runs the main control loop for video encoding. For example, the coding control component 240 performs any processing on the input video sequence that is to be done at the picture level, such as determining the coding type (I, P, or B), i.e., prediction mode, of each picture based on the coding structure, e.g., IPPP, IBBP, hierarchical-B, being used. Coding control component 240 also divides each picture into macroblocks for further processing by the block processing component 242. In addition, coding control component 240 controls the processing of the macroblocks by the block processing component 242 in a pipeline fashion.

Coding control component 240 receives information from block processing component 242 as macroblocks are processed and from the rate control component 244, and uses this information to control the operation of various components in the video encoder. For example, the coding control component 240 provides information regarding quantization scales determined by the rate control component 244 to various components of the block processing component 242 as needed.

FIG. 3 illustrates the basic coding architecture of block processing component 242. One of ordinary skill in the art will understand that the components of this architecture may be mapped to pipelined slave processing modules in an embedded system or be performed by logic modules implemented in software and executed by a single or multiple processors, for example. The macroblocks 300 from the coding control component 240 are provided as one input of a motion estimation component 320, as one input of an intra prediction component 324, and to a positive input of a combiner 302 (e.g., adder or subtractor or the like). Further, although not specifically shown, the prediction mode of each picture as selected by the coding control component 240 is provided to a mode decision component 326, and the entropy encoder 334.

Storage component 318 provides reference data to the motion estimation component 320 and to the motion compensation component 322. The reference data may include one or more previously encoded and decoded macroblocks, i.e., reconstructed macroblocks.

Motion estimation component 320 provides motion estimation information to the motion compensation component 322 and the entropy encoder 334. Motion estimation is performed using an iterative grid-pattern motion search scheme that will be described in more detail below. The motion estimation component 320 may perform tests on macroblocks based on multiple temporal prediction modes using reference data from storage 318 to choose the best motion vector(s)/prediction mode based on a coding cost. To perform the tests, the motion estimation component 320 may divide each macroblock into prediction units according to the unit sizes of prediction modes and calculate the coding costs for each prediction mode for each macroblock. The coding cost calculation may be based on the quantization scale for a macroblock as determined by the rate control component 244.

The motion estimation component 320 provides the selected motion vector (MV) or vectors and the selected prediction mode for each inter-predicted macroblock to the motion compensation component 322 and the selected motion vector (MV) to the entropy encoder 334. Motion estimation component 320 embodies an iterative grid-pattern motion search method that will be described in more detail below. The motion compensation component 322 provides motion compensated inter-prediction information to the mode decision component 326 that includes motion compensated inter-predicted macroblocks and the selected temporal prediction modes for the inter-predicted macroblocks. The coding costs of the inter-predicted macroblocks are also provided to the mode decision component 326.

The intra-prediction component 324 provides intra-prediction information to the mode decision component 326 that includes intra-predicted macroblocks and the corresponding spatial prediction modes. That is, the intra prediction component 324 performs spatial prediction in which tests based on multiple spatial prediction modes are performed on macroblocks using previously encoded neighboring macroblocks of the picture from the buffer 328 to choose the best spatial prediction mode for generating an intra-predicted macroblock based on a coding cost. To perform the tests, the intra prediction component 324 may divide each macroblock into prediction units according to the unit sizes of the spatial prediction modes and calculate the coding costs for each prediction mode for each macroblock. The coding cost calculation may be based on the quantization scale for a macroblock as determined by the rate control component 244. Although not specifically shown, the spatial prediction mode of each intra predicted macroblock provided to the mode decision component 326 is also provided to the transform component 304. Further, the coding costs of the intra predicted macroblocks are also provided to the mode decision component 326.

The mode decision component 326 selects a prediction mode for each macroblock based on the coding costs for each prediction mode and the picture prediction mode. That is, the mode decision component 326 selects between the motion-compensated inter-predicted macroblocks from the motion compensation component 322 and the intra-predicted macroblocks from the intra prediction component 324 based on the coding costs and the picture prediction mode. The output of the mode decision component 326, i.e., the predicted macroblock, is provided to a negative input of the combiner 302 and to a delay component 330. The output of the delay component 330 is provided to another combiner (i.e., an adder) 338. The combiner 302 subtracts the predicted macroblock from the current macroblock to provide a residual macroblock to the transform component 304. The resulting residual macroblock is a set of pixel difference values that quantify differences between pixel values of the original macroblock and the predicted macroblock.

The transform component 304 performs unit transforms on the residual macroblocks to convert the residual pixel values to transform coefficients and provides the transform coefficients to a quantize component 306. The quantize component 306 quantizes the transform coefficients of the residual macroblocks based on quantization scales provided by the coding control component 240. For example, the quantize component 306 may divide the values of the transform coefficients by a quantization scale (Qs). In some embodiments, the quantize component 306 represents the coefficients by using a desired number of quantization steps, the number of steps used (or correspondingly the value of Qs) determining the number of bits used to represent the residuals. Other algorithms for quantization such as rate-distortion optimized quantization may also be used by the quantize component 306.

Because the DCT transform redistributes the energy of the residual signal into the frequency domain, the quantized transform coefficients are taken out of their scan ordering by a scan component 308 and arranged by significance, such as, for example, beginning with the more significant coefficients followed by the less significant. The ordered quantized transform coefficients for a macroblock provided via the scan component 308 along with header information for the macroblock and the quantization scale used are coded by the entropy encoder 334, which provides a compressed bit stream to a video buffer 336 for transmission or storage. The entropy coding performed by the entropy encoder 334 may be use any suitable entropy encoding technique, such as, for example, context adaptive variable length coding (CAVLC), context adaptive binary arithmetic coding (CABAC), run length coding, etc.

The entropy encoder 334 is also responsible for generating and adding slice header information to compressed bit stream when a new slice is started. Note that the coding control component 240 controls when the entropy coded bits of a macroblock are released into the compressed bit stream and also controls when a new slice is to be started. The coding control component 304 may also monitor the slice size to ensure that a slice does not exceed a maximum NAL size. Accordingly, after a macroblock is entropy coded but before it is released into the compressed bit stream, the coding control component 240 may determine whether or not including the current entropy-coded macroblock in the current slice will cause the slice to exceed the maximum NAL size. If the slice size will be too large, the coding control component 240 will cause the entropy encoder 334 to start a new slice with the current macroblock. Otherwise, the coding control component 240 will cause the bits of the entropy coded macroblock to be released into the compressed bit stream as part of the current slice.

Inside the block processing component 242 is an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent pictures. To determine the reconstructed input, i.e., reference data, the ordered quantized transform coefficients for a macroblock provided via the scan component 308 are returned to their original post-transform arrangement by an inverse scan component 310, the output of which is provided to a dequantize component 312, which outputs estimated transformed information, i.e., an estimated or reconstructed version of the transform result from the transform component 304. The dequantize component 312 performs inverse quantization on the quantized transform coefficients based on the quantization scale used by the quantize component 306. The estimated transformed information is provided to the inverse transform component 314, which outputs estimated residual information which represents a reconstructed version of a residual macroblock. The reconstructed residual macroblock is provided to the combiner 338.

The combiner 338 adds the delayed selected macroblock to the reconstructed residual macroblock to generate an unfiltered reconstructed macroblock, which becomes part of reconstructed picture information. The reconstructed picture information is provided via a buffer 328 to the intra-prediction component 324 and to a filter component 316. The filter component 316 is an in-loop filter which filters the reconstructed picture information and provides filtered reconstructed macroblocks, i.e., reference data, to the storage component 318.

The components of the video encoder of FIGS. 2 and 3 may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software instructions may be initially stored in a computer-readable medium such as compact disc (CD), a diskette, a tape, a file, memory, or any other computer readable storage device, and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

### Iterative Grid-Pattern Search

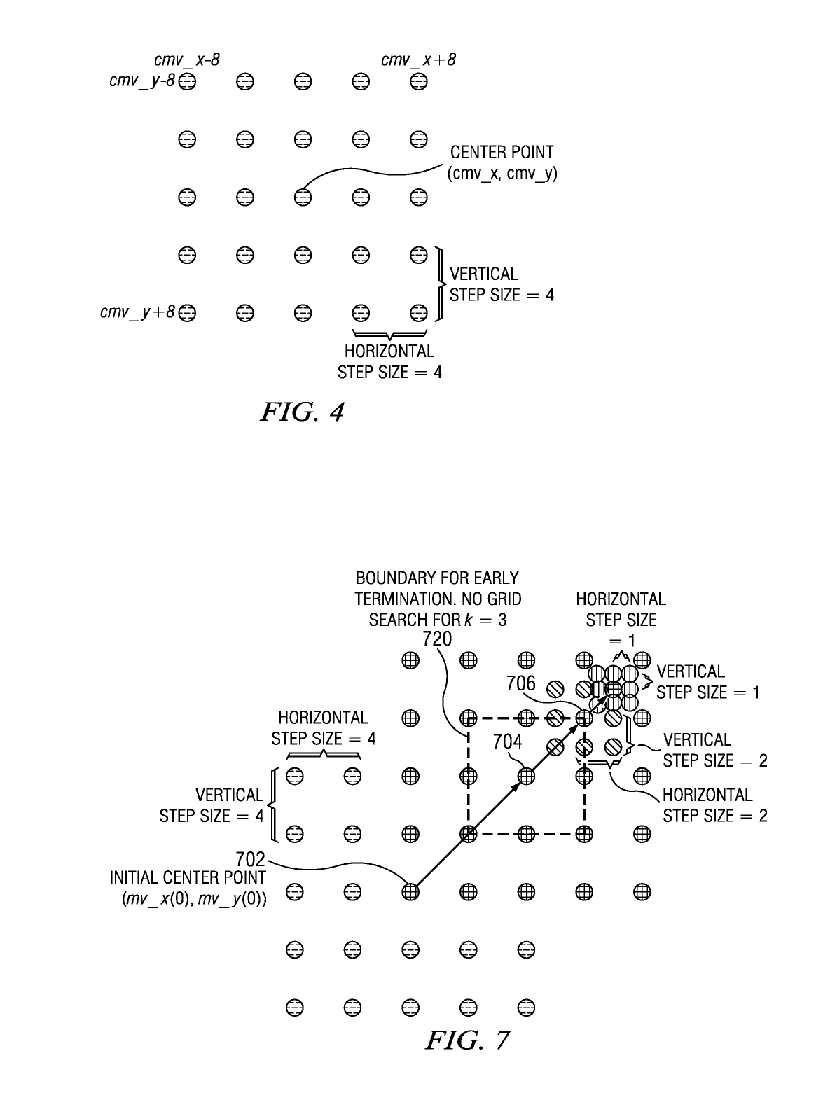

FIGS. 4-7 illustrate iterative grid-pattern motion search by the encoder of FIG. 3. In this method, a grid-pattern integer-pel search for a current block, for example, a macroblock (16×16) or a sub-macroblock in H.264, is performed iteratively. The number of iterations (N) may be determined by available computational power. Typically the total number of search points used for each marocblock determines computational complexity. The available computational power it typically determined by analyzing the number of processing cycles available for a given hardware platform, and then assigning a default value for N based on the processing cycle budget for that hardware platform. In some embodiments, N may be specified dynamically for different frames or different macroblocks. For example, if the encoder is contending with other tasks for computing resources, the computing load presented by the other tasks may affect the computing resource available for use by the encoder, and N may be selected accordingly as the load from other tasks changes. Another option may be to determine an estimated motion magnitude for a given frame and then select one value of N for the frame if a large motion, such a fast panning, is detected, and select a different value for N for frames in which only small amounts of motion is detected. For example, motion estimation may be done for a few macroblocks in a frame and the result used to estimate an amount of motion for the frame.

Let grid(CMV_X, CMV_Y, R_{H}, R_{V}, S_{H}, S_{V}) denote all integer-pel points within a range 2*R_{H} and 2*R_{V} rectangle area around a center MV (CMV_X, CMV_Y) with step size S_{H} and S_{V} in horizontal and vertical direction. For example, when a center position (cmv_x, cmv_y) is given, all search points covered by grid(cmv_x, cmv_y, 8,8,4,4) are shown in FIG. 4. Also, denote (mv_x(k), mv_y(k)) as the best MV of k-th grid search. When k==0, (mv_x(0), mv_y(0)) is an initial search center.

The iteration algorithm may be explained as a series of steps using pseudo-code as follows.
Step 1) Set current number of iterations, k, to 1 (k=1) and set (mv_x(0), mv_y(0)) with an initial center point.
Step 2) Perform motion search for grid(mv_x(k-1), mv_y(k-1),8,8,4,4). This is done for each point in the grid using known techniques. For example, for each search point in the grid, a sum of absolute differences may be determined for all of the points in a block centered around it, compared to the reference MB.
Step 3) If k==1, skip this step. If k>1, check whether the best search point (mv_x(k), mv_y(k)) is same as (mv_x(k-1), mv_y(k-1)). If they are same, then go to Step 5).
Step 4) If k==N, go to step 5), where N is number of iterations determined by available computation budget. Else increase k by 1 and go to Step 2).
Step 5) Increase k by 1 and perform motion search for grid(mv_x(k-1), mv_y(k-1),2,2,2,2).
Step 6) Increase k by 1 and perform search for grid(mv_x(k-1), mv_y(k-1),1,1,1,1).

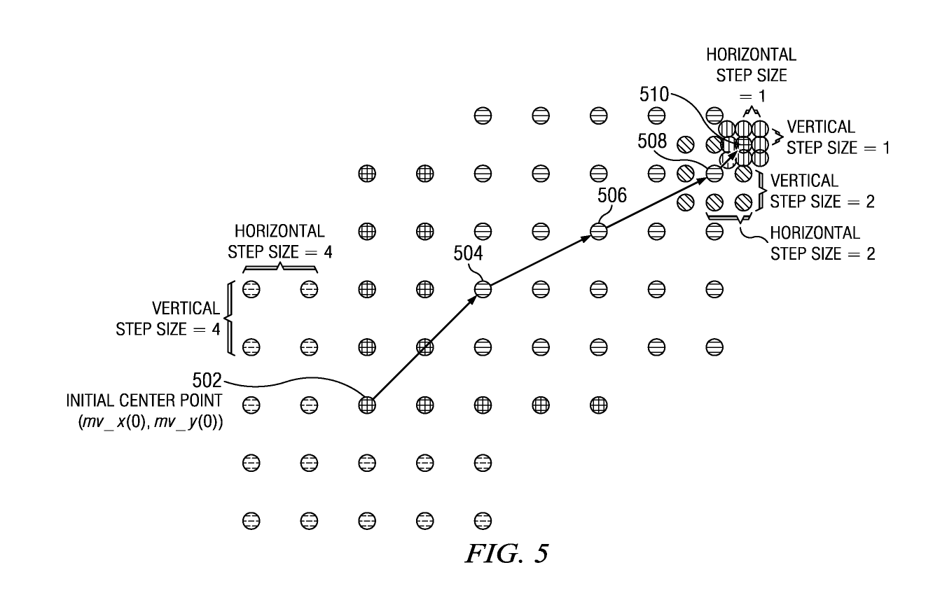

FIG. 5 illustrates a search example for N=3. An initial center point (mv_x(0), mv_y(0)) is indicated at 502. After the first iteration of the motion search, k=1, a best MV predictor is now indicated at 504. After the second iteration of the motion search, k=2, the best MV predictor is now indicated at 506. After the third iteration of the motion search, k=3==N, the best MV predictor is now indicated at 508. At this point, step 5 is performed and the step size is reduced to 2, and the best MV predictor is now indicated at 510. At this point, the step size is reduced to 1 to determine the final best MV predictor.

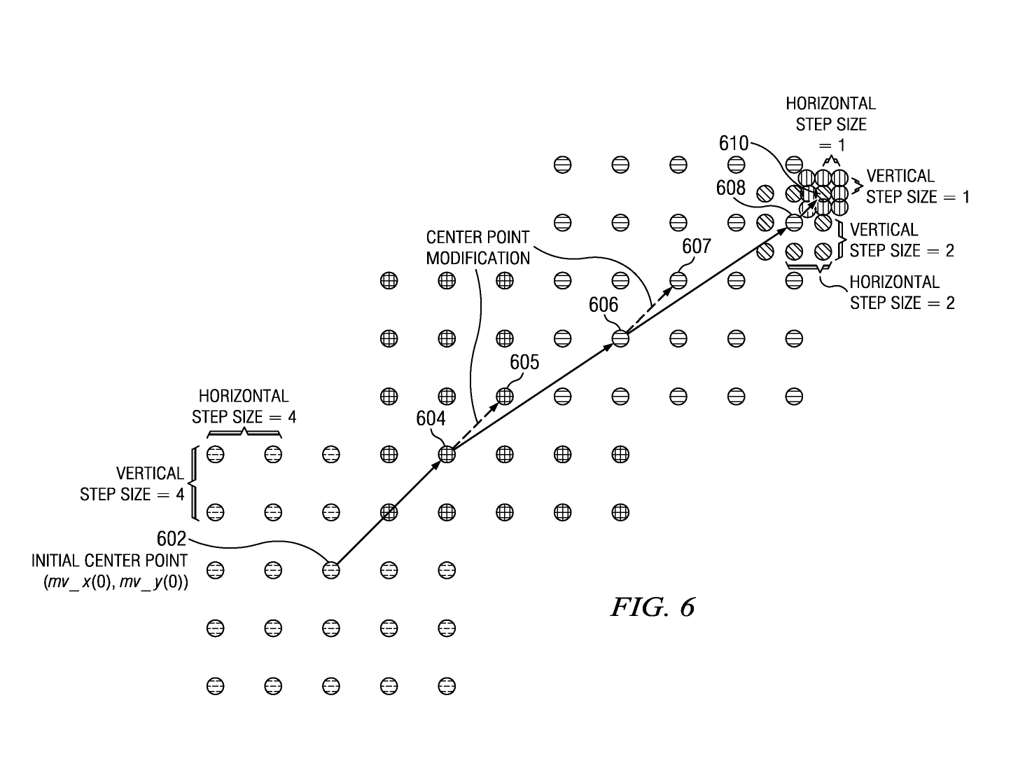

FIG. 6 illustrates a search example for N=3 in which the search center is modified after each iteration in order to find motion direction more quickly. In Step 2), the best MV of (k-1)-th search is used for the center point of k-th search. In order to find motion direction more quickly, the center point of k-th search can be moved to the direction of the best MV of (k-1)-th search. In this case, step 2) is modified as follows:
Step 2) If k==1, perform motion search for grid(mv_x(k-1), mv_y(k-1),8,8,4,4). If k>1, perform motion search for grid(modified_mv_x, modified_mv_y,8,8,4,4), where (modified_mv_x, modified_mv_y) is modified search center calculated as shown in Table 1.

TABLE 1
modified search center calculation

If (mv_x(k−1) > mv_x(k−2)) modified_mv_x = mv_x(k−1) + 4
Else if (mv_x(k−1) < mv_x(k−2)) modified_mv_x = mv_x(k−1) − 4
Else modified_mv_x = mv_x(k−1)
If (mv_y(k−1) > mv_y(k−2)) modified_mv_y = mv_y(k−1) + 4
Else if (mv_y(k−1) < mv_y(k−2)) modified_mv_y = mv_y(k−1) − 4
Else modified_mv_y = mv_y(k−1)

Referring again to FIG. 6, an initial center point set (mv_x(0), mv_y(0)) is indicated at 602. After the first iteration of the motion search, k=1, a best MV predictor is now indicated at 604. However, according to Table 1, the next search center is modified to point 605. After the second iteration of the motion search, k=2, the best MV predictor is now indicated at 606. However, according to Table 1, the next search center is modified to point 607. After the third iteration of the motion search, k=3==N, the best MV predictor is now indicated at 608. In this manner, the best MV predictor is shifted to an adjacent search point in a direction indicated by the current best search point in order to more quickly find the best MV predictor.

At this point, step 5 is performed and the step size is reduced to 2, and the best MV predictor is now indicated at 610. At this point, the step size is reduced to 1 to determine the final best MV predictor.

FIG. 7 illustrates an early termination technique. Referring back to Step 3), a jump is made to Step 5) if (mv_x(k), mv_y(k))==(mv_x(k-1), mv_y(k-1)), which reduces computational load by removing redundant searches without any performance degradation. To further reduce computational load at the cost of prediction accuracy, Step 3) may be modified as follows:
Step 3) If k==1, skip this step. If k>1, |mv_x(k)−mv_x(k-1)|<=4 and |mv_y(k)−mv_y(k-1)|<=4, then go to Step 5).

Early termination for N=3 is illustrated in FIG. 7. An initial center point (mv_x(0), mv_y(0)) is indicated at 702. After the first iteration of the motion search, k=1, a best MV predictor is now indicated at 704. After the second iteration of the motion search, k=2, the best MV predictor is now indicated at 706. In this case, 706 is within the boundary for early termination 720, so an iteration with k=3 is not performed.

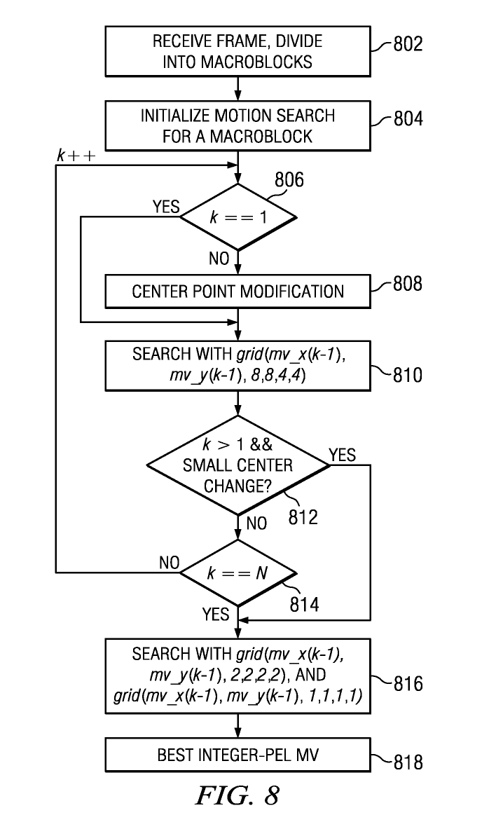

FIG. 8 is a flow diagram illustrating operation of the iterative grid-pattern motion search. As described earlier, an encoder receives 802 a sequence of frames of video data and divides 802 each frame of video data into a plurality of macroblocks each containing an array of picture elements (PELS). A typical macroblock may contain an array of 16×16 pels, but other sizes may also be used.

For each macroblock, a motion vector for the macroblock in a current frame may be estimated relative to a prior frame. The motion vector estimation process may initially 804 determine available computing power and then select a number of iterations, N, to be used. This may be done dynamically based on current loading and availability of processing resources. It may also be done statically by a default value selected by a system designer or administrator, for example. Initialization 806 may also include selection of search point step values and search point range. For example, a step value of four and a range of plus/minus eight would specify an initial five by five array of search points around a center point that completely covers a 16×16 macroblock. For each macroblock, an initial best search point is selected to be in the center of the macroblock and the iteration count k is set to one, as described in more detail with regard to FIG. 4.

On a first iteration 806 when k is one, a motion search is performed 810 on a set of search points in the prior frame corresponding to a sub-set of pels within the macroblock to determine a best search point.

Additional motion searches are performed iteratively 814, 806, wherein each motion search is on a set of search points in the prior frame centered around a best search point determined in a preceding motion search, as described in more detail with regard to FIG. 5.

A final motion vector for the macroblock is then estimated 818 using a best search point determined in a final motion search iteration.

In some embodiments, a center point modification 808 may be performed to improve the rate of convergence to a final motion vector value. In this case, the current best search point is modified prior to performing an additional motion search by shifting to an adjacent search point in a direction indicated by the current best search point, as described in more detail with regard to FIG. 6.

In some embodiments, an early termination 812 of the iteration process may occur when a subsequent best search point is approximately equal to a current best search point. This may be determined to be when the subsequent best search point is within one vertical step and one horizontal step of the current best search point, for example.

In some embodiments, after performing a number N of motion searches, the vertical step size, and/or the horizontal step size may be reduced for the next search set. A motion search is then performed 816 using the reduced size search set. For example, several iterations may be performed with a search array having a step size of four. After one or more iterations, the search array step size may then be reduced to two. Another iteration may then be performed with a search array step size of one.

This process is then repeated for each macroblock in the current frame of video data. Encoding may then be performed using the estimated motion vectors as described in more detail with regard to FIG. 3.

### Dual Grid-Pattern (4-2-1 Step) Search

In another method, a fixed number of iterations may be performed with different search grid sizes. For example, a 4-2-1 step size sequence may be used. After a first set of iterations is performed, a second set may then be performed. This iteration sequence may be explained as a series of steps using pseudo-code as follows.
Step 1) Set current number of iterations, k, to 1 (k=1) and set (mv_x(0), mv_y(0)) with a best initial MV predictor. Let the best initial MV predictor denote (best_mv_x, best_mv_y).
Step 2) Perform motion search for grid(mv_x(k-1), mv_y(k-1),4,4,4,4).
Step 3) Increase k by 1 and perform motion search for grid(mv_x(k-1), mv_y(k-1),2,2,2,2).
Step 4) Increase k by 1 and perform search for grid(mv_x(k-1), mv_y(k-1),1,1,1,1).

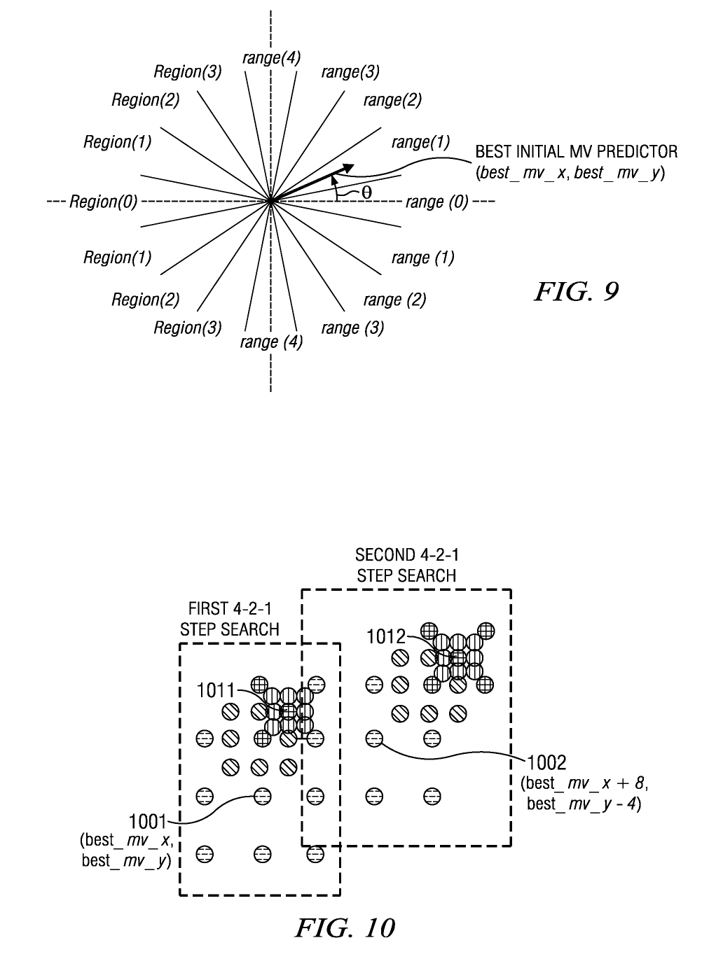

Step 5) Repeat Step 1 through Step 4 except using different (mv_x(0), mv_y(0)). In Step 1, Set (mv_x(0), mv_y(0)) to (best mv_x+offset_x, best_mv_y+offset_y), where offset_x and offset_y are offsets for horizontal and vertical components, respectively. offset_x and offset_y can be determined based on number of angle ranges (R). For example, for R=5, the angle of each range is 22.5 degrees; (90 degree/(5-1)=22.5 degree). FIG. 9 illustrates a set of angle ranges for R=5. offset_x and offset_y may be calculated as follows:

offset_{—}x=sign_{—}x*S1 and offset_{—}y=0 if theta is within range(0)

offset_{—}x=sign_{—}x*S1 and offset_{—}y=sign_{—}y*S2 if theta is within range(1)

offset_{—}x=sign_{—}x*S1 and offset_{—}y=sign_{—}y*S1 if theta is within range(2)

offset_{—}x=sign_{—}x*S2 and offset_{—}y=sign_{—}y*S1 if theta is within range(3)

offset_{—}x=sign_{—}x*0 and offset_{—}y=sign_{—}y*S1 if theta is within range(4)

where sign_x and sign_y are signs of best_mv_x and best_mv_y, respectively, and S1 and S2 are offset sizes that can be determined based on the size of global or local motion offset. theta is the angle of the best initial MV predictor and range(r) is r-th angle range. For example, when initial MV=(x,y) where x=y, then theta=45 degree. If initial MV=(0,0), it may be considered within range(0) in FIG. 9 and offset is determined by first rule above (offset_x=sign_x*S1 and offset_y=0).

FIG. 10 illustrates a dual 4-2-1 step search. In this example, R=5, S1=8 and S2=4 when theta is within range(1). Search point 1001 is the initial best MV predictor used during the first iteration of the first set of 4-2-1 searches and search point 1011 is the initial best MV predictor used during the last iteration of the first set of 4-2-1 searches, while search point 1002 is the best MV predictor used in the first iteration of the second set of 4-2-1 searches and search point 1012 is the best MV predictor used in the last iteration of the second set of 4-2-1 searches. Search point 1002 is determined based on theta as described above with regard to FIG. 9.

### Experimental Results

The algorithms described above were tested using a robust H.264 encoder. Each test used 1080p videos, with 30˜60 frames for each video. Table 2 illustrates the PSNR improvement for same bit-rate for iterative searches with various values of N as compared to a standard 4-2-1 search for several known sample video clips. For this test, four cases were tested, N=1, 2, 3 and 4, and compared to a 4-2-1 step search. The iterative approach gives substantial PSNR (peak signal to noise ratio) improvement especially over complex and fast panning videos. Also the iterative algorithm shows good scalability on applications with different computational budgets. The tests are configured as follows:
Test0: default algorithm (integer-pel 4-2-1 step search);
Test1: Integer-pel grid-pattern search with N=1;
Test2: Integer-pel grid-pattern search with N=2;
Test3: Integer-pel grid-pattern search with N=3;
Test4: Integer-pel grid-pattern search with N=4.

TABLE 2
PSNR improvement for same bit-rate of iterative grid pattern
search vs. 4-2-1 search

| | Test1 vs. | Test2 vs. | Test3 vs. | Test4 vs. |
|---|---|---|---|---|
| | Test0 | Test0 | Test0 | Test0 |
| sbreach | 0.11 | 0.16 | 0.19 | 0.20 |
| smotionvipertraffic | 0.12 | 0.20 | 0.23 | 0.24 |
| sPanIceHockey | 0.15 | 0.24 | 0.28 | 0.29 |
| ssunflower | 0.05 | 0.10 | 0.13 | 0.13 |
| stractor | 0.04 | 0.07 | 0.09 | 0.10 |
| svipertrain | 0.09 | 0.13 | 0.16 | 0.17 |
| snoreservations | 0.05 | 0.08 | 0.09 | 0.10 |
| sgoldendoor | 0.09 | 0.14 | 0.17 | 0.18 |
| sfish | 0.06 | 0.09 | 0.11 | 0.11 |
| sfoolsgold | 0.07 | 0.12 | 0.14 | 0.15 |
| sfire | 0.04 | 0.07 | 0.08 | 0.09 |
| Average | 0.08 | 0.13 | 0.15 | 0.16 |

Table 3 illustrates the performance of center point modification. Experimental results show that Test2 (center position modification method) gives almost the same quality as Test1 with less computation, i.e., N=3. The tests were configured as follows:
Test0: default algorithm (integer-pel 4-2-1 step search)
Test1: Integer-pel grid-pattern search with N=4 (without center position modification)
Test2: Integer-pel grid-pattern search with N=3 (with center position modification)

TABLE 3
PSNR improvement of iterative grid pattern with center
modification vs. 4-2-1 search

| | Test1 vs. | Test2 vs. |
|---|---|---|
| | Test0 | Test0 |
| sbreach | 0.20 | 0.21 |
| smotionvipertraffic | 0.24 | 0.25 |
| sPanIceHockey | 0.29 | 0.30 |
| ssunflower | 0.13 | 0.14 |
| stractor | 0.10 | 0.10 |
| svipertrain | 0.17 | 0.17 |
| snoreservations | 0.10 | 0.10 |
| sgoldendoor | 0.18 | 0.19 |
| sfish | 0.11 | 0.12 |
| sfoolsgold | 0.15 | 0.15 |
| sfire | 0.09 | 0.09 |
| Average | 0.16 | 0.17 |

Table 4 illustrates the performance of early termination. Test2 (early termination with loss) causes little performance degradation but it is expected to save computation for low motion or uniform motion videos. The tests were configured as follows:
Test0: default algorithm (integer-pel 4-2-1 step search);
Test1: Integer-pel grid-pattern search with N=4 (early termination without loss);
Test2: Integer-pel grid-pattern search with N=4 (early termination with loss).

TABLE 4
PSNR improvement for early termination results

| | Test1 vs. | Test2 vs. |
|---|---|---|
| | Test0 | Test0 |
| sbreach | 0.20 | 0.19 |
| smotionvipertraffic | 0.24 | 0.23 |
| sPanIceHockey | 0.29 | 0.29 |
| ssunflower | 0.13 | 0.13 |
| stractor | 0.10 | 0.09 |
| svipertrain | 0.17 | 0.16 |
| snoreservations | 0.10 | 0.09 |
| sgoldendoor | 0.18 | 0.17 |
| sfish | 0.11 | 0.11 |
| sfoolsgold | 0.15 | 0.15 |
| sfire | 0.09 | 0.08 |
| Average | 0.16 | 0.15 |

Table 5 illustrates performance of the dual grid-pattern (4-2-1 step) search described with regard to FIG. 10 to an iterative grid-pattern search with N=1. In this test, only two angle regions (R=2) for dual 4-2-1 step search are used, i.e., best initial MV predictor is shifted for second search center only in vertical or horizontal direction, and S1=32 (S2 is not used in this test). The performance of dual 4-2-1 step search is slightly better than the grid-pattern search with N=1 with similar computational complexity. The tests were configured as follows:
Test0: default algorithm (integer-pel 4-2-1 step search);
Test1: Integer-pel grid-pattern search with N=1;
Test2: Integer-pel dual 4-2-1 step search (R=2, S1=32).

TABLE 5
PSNR improvement for dual 4-2-1 step search vs. N = 1

| | Test1 vs. | Test2 vs. |
|---|---|---|
| | Test0 | Test0 |
| sbreach | 0.11 | 0.05 |
| smotionvipertraffic | 0.12 | 0.10 |
| sPanIceHockey | 0.15 | 0.12 |
| ssunflower | 0.05 | 0.13 |
| stractor | 0.04 | 0.05 |
| svipertrain | 0.09 | 0.04 |
| snoreservations | 0.05 | 0.02 |
| sgoldendoor | 0.09 | 0.01 |
| sfish | 0.06 | 0.00 |
| sfoolsgold | 0.07 | 0.03 |
| sfire | 0.04 | 0.02 |
| Average | 0.08 | 0.05 |

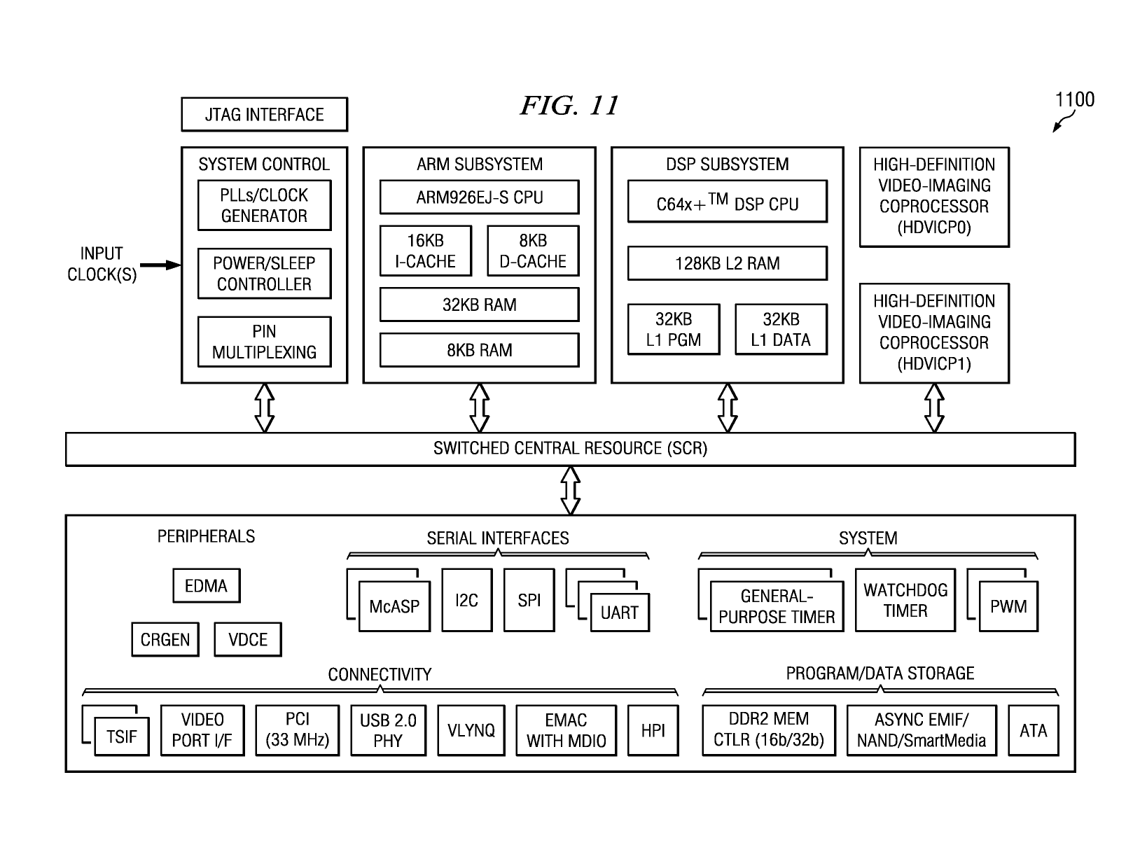

FIG. 11 is a block diagram of an example digital system suitable for use as an embedded system that may be configured to perform iterative grid-pattern motion search as described herein. This example system-on-a-chip (SoC) is representative of one of a family of DaVinci™ Digital Media Processors, available from Texas Instruments, Inc. This SoC is described in more detail in “TMS320DM6467 Digital Media System-on-Chip”, SPRS403G, December 2007 or later, which is incorporated by reference herein.

The SoC 600 is a programmable platform designed to meet the processing needs of applications such as video encode/decode/transcode/transrate, video surveillance, video conferencing, set-top box, medical imaging, media server, gaming, digital signage, etc. The SoC 600 provides support for multiple operating systems, multiple user interfaces, and high processing performance through the flexibility of a fully integrated mixed processor solution. The device combines multiple processing cores with shared memory for programmable video and audio processing with a highly-integrated peripheral set on common integrated substrate.

The dual-core architecture of the SoC 600 provides benefits of both DSP and Reduced Instruction Set Computer (RISC) technologies, incorporating a DSP core and an ARM926EJ-S core. The ARM926EJ-S is a 32-bit RISC processor core that performs 32-bit or 16-bit instructions and processes 32-bit, 16-bit, or 8-bit data. The DSP core is a TMS320C64x+TM core with a very-long-instruction-word (VLIW) architecture. In general, the ARM is responsible for configuration and control of the SoC 600, including the DSP Subsystem, the video data conversion engine (VDCE), and a majority of the peripherals and external memories. The switched central resource (SCR) is an interconnect system that provides low-latency connectivity between master peripherals and slave peripherals. The SCR is the decoding, routing, and arbitration logic that enables the connection between multiple masters and slaves that are connected to it.

The SoC 600 also includes application-specific hardware logic, on-chip memory, and additional on-chip peripherals. The peripheral set includes: a configurable video port (Video Port I/F), an Ethernet MAC (EMAC) with a Management Data Input/Output (MDIO) module, a 4-bit transfer/4-bit receive VLYNQ interface, an inter-integrated circuit (I2C) bus interface, multichannel audio serial ports (McASP), general-purpose timers, a watchdog timer, a configurable host port interface (HPI); general-purpose input/output (GPIO) with programmable interrupt/event generation modes, multiplexed with other peripherals, UART interfaces with modem interface signals, pulse width modulators (PWM), an ATA interface, a peripheral component interface (PCI), and external memory interfaces (EMIFA, DDR2). The video port I/F is a receiver and transmitter of video data with two input channels and two output channels that may be configured for standard definition television (SDTV) video data, high definition television (HDTV) video data, and raw video data capture.

As shown in FIG. 6, the SoC 600 includes two high-definition video/imaging coprocessors (HDVICP) and a video data conversion engine (VDCE) to offload many video and image processing tasks from the DSP core. The VDCE supports video frame resizing, anti-aliasing, chrominance signal format conversion, edge padding, color blending, etc. Each HDVICP coprocessor can perform a single 1080p60 H.264 encode or decode or multiple lower resolution or frame rate encodes/decodes. The HDVICP coprocessors are designed to perform computational operations required for video encoding such as motion estimation, motion compensation, mode decision, transformation, and quantization. Further, the distinct circuitry in the HDVICP coprocessors that may be used for specific computation operations is designed to operate in a pipeline fashion under the control of the ARM subsystem and/or the DSP subsystem.

As was previously mentioned, the SoC 600 may be configured to perform video encoding in which an iterative grid-pattern search is used for integer-pel motion refinement to produce accurate prediction. Computation complexity of the method can be easily controlled by adjusting the number of grid-pattern search iterations. Iterative grid-pattern search substantially improves encoding efficiency for videos with fast panning and complex motion. The iteration process may include an early termination algorithm to reduce redundant computation for low or uniform motion videos. For example, the coding control 240 and rate control 244 of the video encoder of FIG. 2 may be executed on the DSP subsystem or the ARM subsystem and at least some of the computational operations of the block processing 242 may be executed on the HDVICP coprocessors.

### Other Embodiments

While the invention has been described with respect to a limited number of embodiments, those skilled in the art, having benefit of this disclosure, will appreciate that other embodiments can be devised which do not depart from the scope of the invention as disclosed herein. For example, while an initial 5×5 square search grid that covered a 16×16 macrocell was described herein, other sizes of search grid may be selected. A non-square search grid may be used, such as a hexagonal or octagonal array, for example.

While various embodiments have been described herein in reference to the H.264 standard, embodiments for other coding standards will be understood by one of ordinary skill in the art. Such video compression standards include, for example, the Moving Picture Experts Group (MPEG) video compression standards, e.g., MPEG-1, MPEG-2, and MPEG-4, the ITU-T video compressions standards, e.g., H.263, H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), ITU-T/ISO High Efficiency Video Coding (HEVC) standard, etc. Accordingly, embodiments of the invention should not be considered limited to the H.264 video coding standard. Further, the term macroblock as used herein refers to block of image data in a picture used for block-based video encoding. One of ordinary skill in the art will understand that the size and dimensions of a macroblock are defined by the particular video coding standard in use, and that different terminology may be used to refer to such a block.

Embodiments of the iterative grid-pattern motion search scheme described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope of the invention.

What is claimed is:

1. A method for encoding a picture in a video sequence, the method comprising:
receiving a sequence of frames of video data;
dividing each frame of video data into a plurality of macroblocks each containing a plurality of picture elements (PELS); and
estimating a motion vector for a macroblock in a current frame relative to a prior frame, wherein estimating the motion vector comprises:
performing a first motion search from an initial best search point on a set of search points in the prior frame corresponding to a sub-set of pels within the macroblock to determine a best search point;
iteratively performing additional motion searches, wherein each motion search is on a set of search points in the prior frame centered around a best search point determined in a preceding motion search; and
estimating the motion vector for the macroblock using a best search point determined in a final motion search iteration.

2. The method of claim 1, further comprising modifying the current best search point prior to performing an additional motion search by shifting to an adjacent search point in a direction indicated by the current best search point.

3. The method of claim 1, wherein an initial set of search points are separated by a vertical step size and a horizontal step size.

4. The method of claim 3, wherein an additional set of search points uses a smaller step size than the initial set of search points

5. The method of claim 4, wherein each set of search points from a square grid.

6. The method of claim 1, wherein iteratively performing additional motion searches is limited to a maximum number of iterations N.

7. The method of claim 1, wherein performing additional motion search is stopped when a subsequent best search point is approximately equal to a current best search point.

8. The method of claim 3, wherein performing additional motion search is stopped when the subsequent best search point is within one vertical step and one horizontal step of the current best search point.

9. The method of claim 3, wherein after performing a number N of motion searches, the vertical step size and/or the horizontal step size is reduced for the next additional search set.

10. The method of claim 6, further comprising:
determining an amount of available computational resources; and
selecting the N based on the amount of available computing resources.

11. A computer readable medium storing software instructions that when executed in a digital system cause the digital system to perform a method for encoding for encoding a picture in a video sequence, the method comprising:
receiving a sequence of frames of video data;
dividing each frame of video data into a plurality of macroblocks each containing a plurality of picture elements (PELS); and
estimating a motion vector for a macroblock in a current frame relative to a prior frame, wherein estimating the motion vector comprises:
performing a first motion search from an initial best search point on set of search points in the prior frame corresponding to a sub-set of pels within the macroblock to determine a best search point;
iteratively performing additional motion searches, wherein each motion search is on a set of search points in the prior frame centered around a best search point determined in a preceding motion search; and
estimating the motion vector for the macroblock using a best search point determined in a final motion search iteration.

12. The method of claim 11, further comprising modifying the current best search point prior to performing an additional motion search by shifting to an adjacent search point in a direction indicated by the current best search point.

13. An apparatus configured to encode a picture in a video sequence, the apparatus comprising:
a video capture module operable to receive a sequence of frames of video data;
a block processing module operable to divide each sequence of frames of video data into a plurality of macroblocks each containing a plurality of picture elements (PELS); and
a motion estimation module operable to estimate a motion vector for a macroblock in a current frame relative to a prior frame, wherein estimating the motion vector comprises:
performing a first motion search from an initial best search point on set of search points in the prior frame corresponding to a sub-set of pels within the macroblock to determine a best search point;
iteratively performing additional motion searches, wherein each motion search is on a set of search points in the prior frame centered around a best search point determined in a preceding motion search; and
estimating the motion vector for the macroblock using a best search point determined in a final motion search iteration.

14. The apparatus of claim 13, further comprising modifying the current best search point prior to performing an additional motion search by shifting to an adjacent search point in a direction indicated by the current best search point.

15. The apparatus of claim 13, wherein an initial set of search points are separated by a vertical step size and a horizontal step size.

16. The apparatus of claim 15 wherein an additional set of search points uses a smaller step size than the initial set of search points

17. The apparatus of claim 13, wherein iteratively performing additional motion searches is limited to a maximum number of iterations N.

18. The apparatus of claim 15, wherein performing additional motion search is stopped when the subsequent best search point is within one vertical step and one horizontal step of the current best search point.

19. The apparatus of claim 15, wherein after performing a number N of motion searches, the vertical step size and/or the horizontal step size is reduced for the next additional search set.

20. The apparatus of claim 6, further comprising:
determining an amount of available computational resources; and
selecting the N based on the amount of available computing resources.
